(19) United States
(12) Patent Application Publication
(10) Pub. No.: US 2026/0312932 A1
(43) Pub. Date: Oct. 8, 2026

(54) SEMICONDUCTOR DEVICE AND METHOD FOR DRIVING THE SAME

(71) Applicant: Renesas Electronics Corporation, Tokyo (JP)

(72) Inventors: Takashi OKI, Tokyo (JP); Shogo KATO, Tokyo (JP); Takuro NISHIKAWA, Tokyo (JP)

(21) Appl. No.: 19/456,655

(22) Filed: Jan. 22, 2026

(30) Foreign Application Priority Data
Mar. 3, 2025 (JP) 2025-032723

(51) Int. Cl. H04L 61/00; H04L 12/413; H04L 12/40; H04L 101/622

(52) U.S. Cl. CPC H04L 61/35; H04L 12/413; H04L 2012/40273; H04L 2101/622

(57) ABSTRACT

A semiconductor device provides reduction of communication power consumption using a filter circuit that realizes a partial network. The semiconductor device includes a PLCA circuit for physical collision avoidance, a MAC address circuit with an MCU-specific MAC address included in the ECU, and a filter circuit that determines whether the MAC address included in the received data matches the MCU-specific MAC address.

### CROSS-REFERENCE TO RELATED APPLICATIONS

The disclosure of Japanese Patent Application No. 2025-032723 filed on March 3, 2025, including the specification, drawings and abstract is incorporated herein by reference in its entirety.

### BACKGROUND

The present disclosure relates to a semiconductor device and a method for driving a semiconductor device.

There are disclosed techniques listed below.

[Patent Document 1] Japanese Unexamined Patent Application Publication No. 2012-99006

Patent Document 1 discloses a communication device that reduces power consumption in communication. In recent in-vehicle communication standards (e.g., Ethernet-T1S), there are deviation limits such as ±100ppm to achieve a communication speed of about 10Mbps, thus operating with a high-precision clock (Phase Locked Loop: PLL).

A partial network is a communication method defined in CAN, etc., where only specific devices among multiple devices connected via a bus in standby operation are activated. In communication standards such as Ethernet-T1S, which do not define a partial network, a start-up request is generated for all ECUs connected via the bus. Unnecessary ECUs are also activated, resulting in unnecessary current consumption.

In related technologies, it is necessary to operate the PLL, which is a high-precision clock, even in standby mode to supply the clock, consuming several mA for the operation of the Oscillator and PLL alone, and several tens of mA in the ECU. Therefore, if there are 100 ECUs in a vehicle, several amperes of current may be generated even in standby mode.

### SUMMARY

Accordingly, the purpose of the present disclosure is to provide a semiconductor device that reduces power consumption in communication by using a filter circuit to realize a partial network.

Other objects and novel features will become apparent from the description of this specification and the accompanying drawings.

According to one embodiment, the semiconductor device includes a filter circuit that determines whether the MAC (Media Access Control) address included in the received data matches the unique MAC address of the MCU (Micro Controller Unit).

According to the above embodiment, a semiconductor device can be provided that reduces power consumption in communication by using a filter circuit to realize a partial network.

### BRIEF DESCRIPTION OF THE DRAWINGS

FIG. 1 is a block diagram illustrating the configuration of a related semiconductor device.

FIG. 2 is a schematic diagram illustrating a partial network.

FIG. 3 is a block diagram illustrating the configuration of the semiconductor device of the present disclosure.

FIG. 4 is a timing chart showing the timing of received data and a low-precision clock.

FIG. 5 is a timing chart showing the timing of the change from a high-precision clock to a low-precision clock.

FIG. 6 is a timing chart showing the timing of the change from a low-precision clock to a high-precision clock.

### DETAILED DESCRIPTION

For clarity of explanation, the following description and drawings are appropriately omitted and simplified. Also, each element described in the drawings as a functional block for performing various processes can be configured by hardware, such as a CPU (Central Processing Unit), memory, and other circuits, and can be implemented by software, such as programs loaded into memory. Therefore, these functional blocks can be realized by hardware, software operating on hardware, or a combination thereof. In the drawings, the same elements are denoted by the same reference numerals, and a repetitive description thereof is omitted as necessary.

Also, the programs described above may be stored and provided to a computer using various types of non-transitory computer readable media. Non-transitory computer readable media includes various types of tangible storage media. Examples of non-transitory computer-readable media include magnetic recording media (e.g., flexible disks, magnetic tapes, hard disk drives), magneto-optical recording media (e.g., magneto-optical disks), CD-ROM (Read Only Memory, a CD-R, a CD-R/W, solid-state memories (e.g., masked ROM, PROM(Programmable ROM), EPROM (Erasable PROM, flash ROM, RAM (Random Access Memory)). The programs may also be supplied to the computer by various types of transitory computer-readable transitory computer readable media. Examples of transitory computer-readable media include electrical signals, optical signals, and electromagnetic waves. The transitory computer readable medium may provide the program to the computer via wired or wireless communication paths, such as electrical wires and optical fibers.

### Description of Related Semiconductor Device

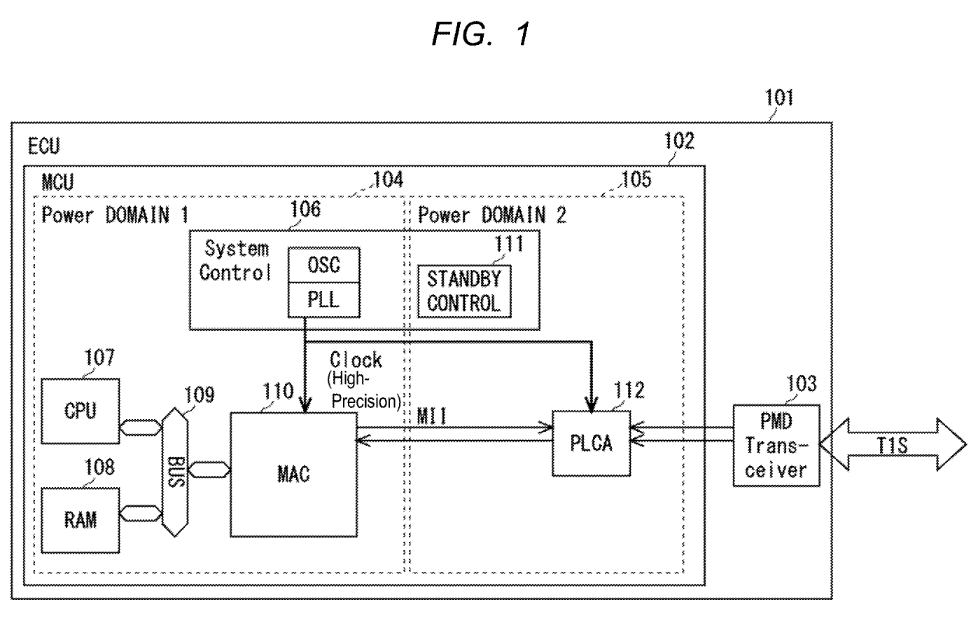

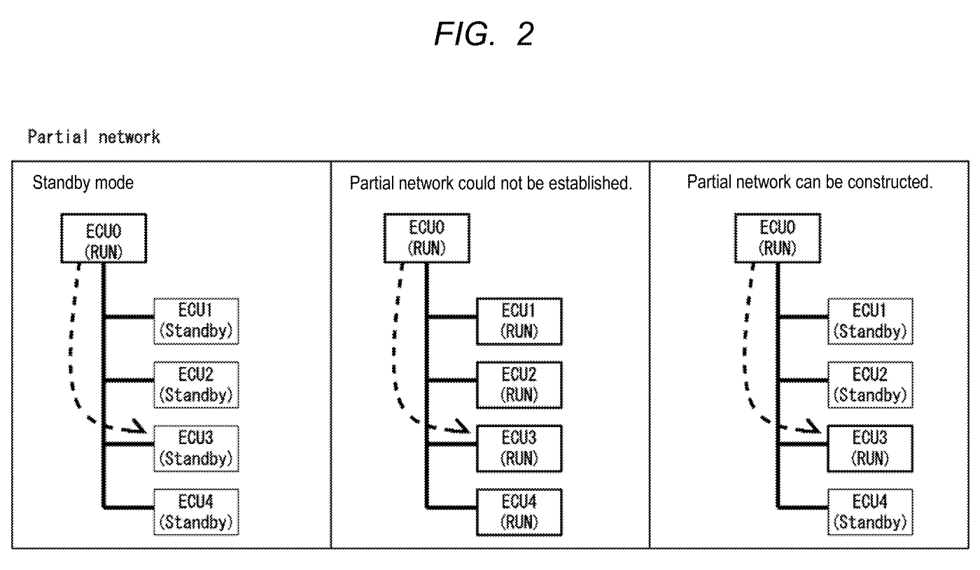

FIG. 1 is a block diagram illustrating the configuration of a related semiconductor device. FIG. 2 is a schematic diagram illustrating a partial network. Referring to FIGS. 1 and 2, the related semiconductor device will be described. A semiconductor device is a device composed of circuits using semiconductors. Here, a device including an in-vehicle ECU (Electronic Control Unit) is referred to as a semiconductor device.

As shown in FIG. 1, the semiconductor device 101 including an ECU comprises an MCU (Micro Control Unit) 102 and a PMD transceiver (Transceiver) 103.

The PMD transceiver 103 has a function of communicating with other ECUs inside the vehicle. The PMD transceiver communicates using a standard called Ethernet (registered trademark)-T1S.

The MCU 102 includes a power domain (Power DOMAIN) 1 (104) that is powered on and off, and a power domain (Power DOMAIN) 2 (105) that is always powered on. The power domain 1 (104) includes a CPU (Central Processing Unit) 107, a RAM (Random Access Memory) 108, a bus (BUS) 109, a MAC (Media Access Control) address circuit 110, and a system control (System Control) circuit 106 that includes an oscillator (Oscillator: OSC as shown) and a PLL (Phase Locked Loop) circuit.

The CPU 107 executes programs to perform processing. The RAM 108 stores programs. The bus 109 connects each element constituting the MCU 102. The MAC address circuit 110 has a unique MAC address of the MCU 102.

The oscillator generates a high-precision clock. The PLL circuit multiplies the high-precision clock. The high-precision clock is supplied, and the semiconductor device 101 is driven.

The power domain 2 (105) includes a standby control circuit 111 and a PLCA (PHY Level Collision Avoidance) circuit 112. The standby control circuit switches the high-precision clock circuit from standby to active state. The PLCA circuit 112 avoids physical collisions in communication.

As shown in the left diagram of FIG. 2, in the related semiconductor device, the main ECU0 is in the active (Run) state during standby. However, the subordinate ECUs connected to the main ECU0, ECU1, ECU2, ECU3, and ECU4, are in standby state.

In the related semiconductor device, a partial network could not be established. Therefore, as shown in the middle diagram of FIG. 2, when ECU0 activates ECU3, ECU1, ECU2, and ECU4 are also activated. For example, if there are 100 subordinate ECUs, even trying to activate one ECU can result in power consumption of several amperes.

As shown in the right diagram of FIG. 2, if a partial network can be constructed, ECU0 can activate only ECU3. Therefore, power consumption can be limited to several tens of mA.

### Description of the Semiconductor Device According to the Embodiment

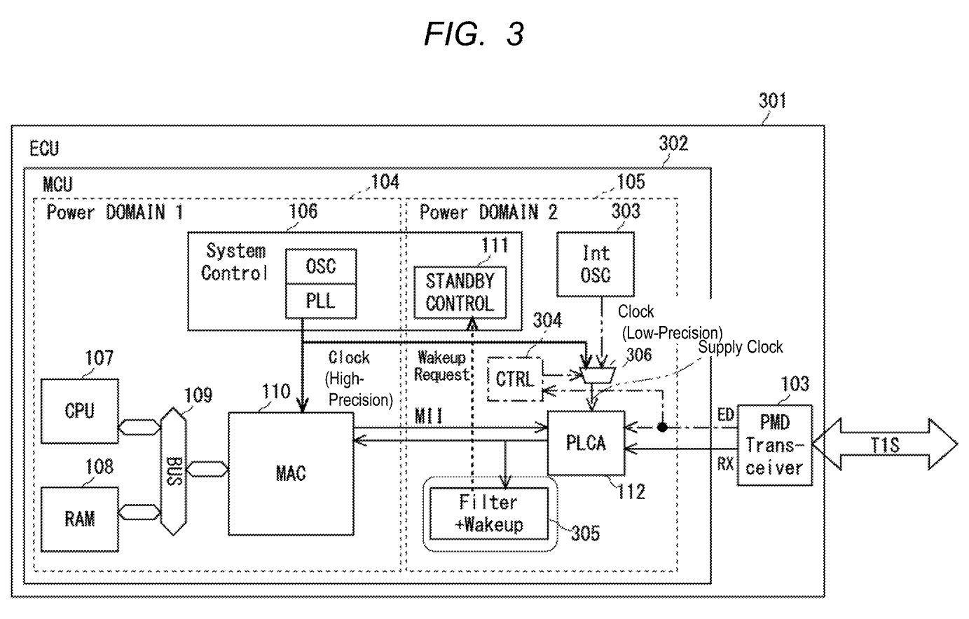

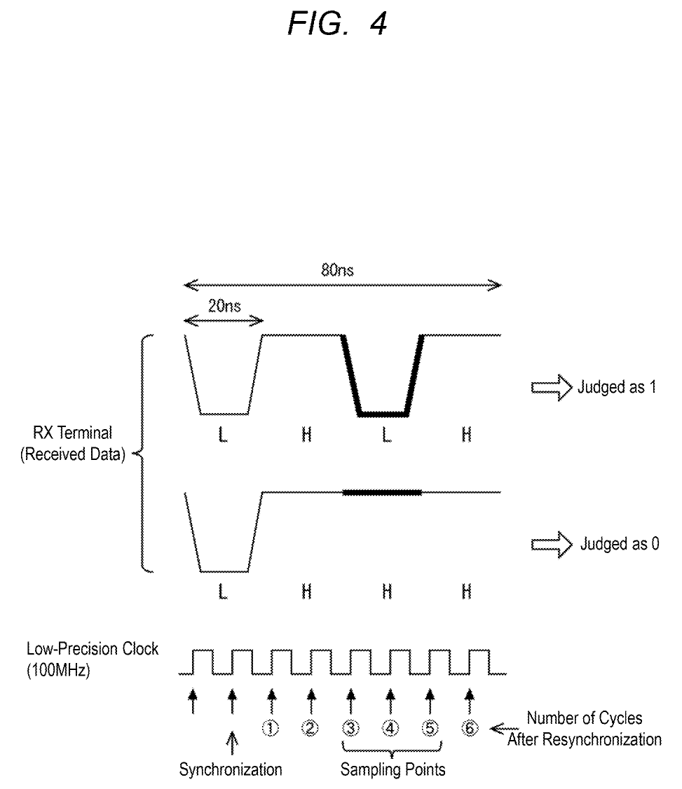

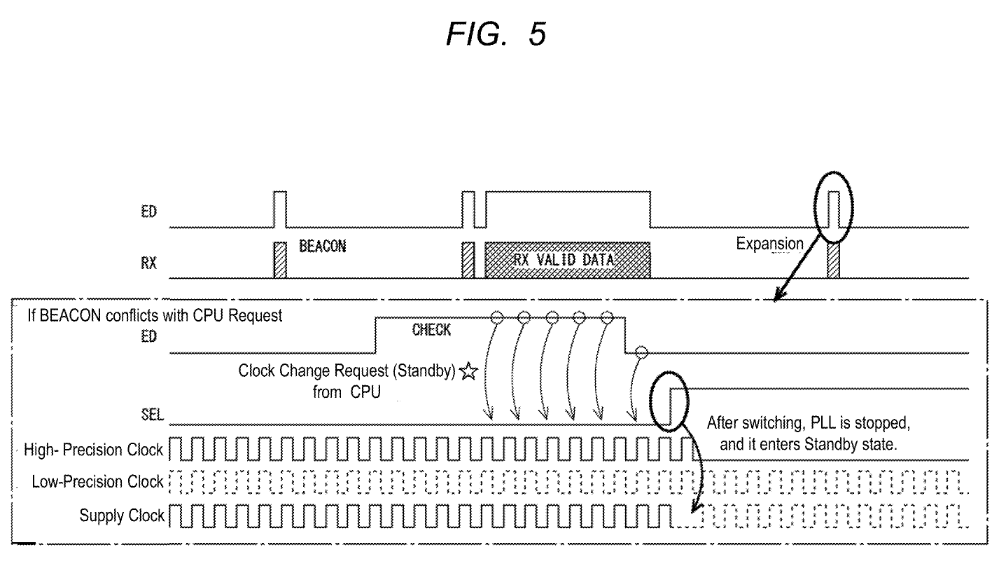

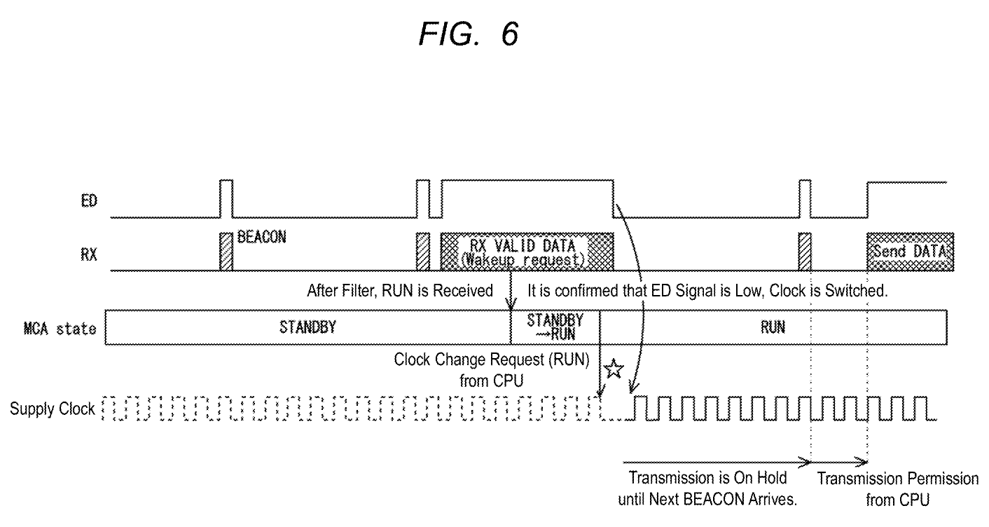

FIG. 3 is a block diagram illustrating the configuration of the semiconductor device of the present disclosure. FIG. 4 is a timing chart showing the timing of received data and a low-precision clock. FIG. 5 is a timing chart showing the timing of the change from a high-precision clock to a low-precision clock. FIG. 6 is a timing chart showing the timing of the change from a low-precision clock to a high-precision clock. Referring to FIGS. 3 to 6, the semiconductor device according to the embodiment will be described.

As shown in FIG. 3, the semiconductor device 301 according to the embodiment further includes a low-precision clock circuit (Internal Oscillator: Int OSC as shown) 303, a control (Control: CTRL as shown) circuit 304, a selector circuit 306, and a filter circuit (Filter + Wakeup as shown) 305 in addition to the related semiconductor device 101.

The low-precision clock circuit 303 provides a low-precision clock to PLCA circuit 112 during standby to reduce power consumption. The clock oscillated from the low-precision clock circuit 303 is, for example, about 10 percent error, about 100MHz. The low-precision clock can generally be realized by a simple clock source such as a ring oscillator and can operate at a constant voltage with a constant current of several tens of μA.

Upon returning from standby state, only the receiving operation is performed. In the packet data that triggers the return operation, receiving data with a pulse width of 20ns will initiate the return operation. Therefore, reception is possible even with a low-precision clock. Thus, the operating clock during standby is set to a low-precision clock.

After startup, if transmission becomes necessary, the transmission operation begins after switching to a high- precision clock. During standby operation, switching to a low-precision clock enables low-current operation.

The filter circuit 305 is connected to the PLCA circuit. Additionally, the filter circuit 305 is connected to the standby control circuit 111. The filter circuit 305 is equipped with a filtering function that determines whether the MAC address of the received data matches the unique MAC address of the MCU 302. If both MAC addresses match, the filter circuit 305 sends a wakeup signal (Wakeup Request) to the standby control circuit 111, which then activates the high-precision clock circuit.

The selector circuit 306 is a circuit that switches between the high-precision clock and the low-precision clock. During standby mode and data reception, it switches to the low-precision clock, allowing the PLL and high-precision clock circuit to be stopped. Standby time refers to, for example, when the MAC address included in the received data does not match the unique MAC address of the MCU 302. The control circuit 304 checks the communication status on the bus to control switching so that no switching occurs during communication.

Since it is necessary to keep the power on during standby, the standby control circuit 111, the constant precision clock circuit 303, the control circuit 304, the selector circuit 306, the PLCA circuit 112, and the filter circuit 305 are placed in power domain 2, which is the first area where power is always input.

During standby, the power is turned off, so the CPU 107, RAM 108, high-precision clock circuit, PLL circuit, and MAC address circuit 110 are placed in power domain 1, which is the second area where power is not always input.

The PMD transceiver 103 sends an ED signal indicating the communication status on the bus and an RX signal indicating data to the MCU 302.

As shown in FIG. 4, consider that an RX signal with a pulse width of 20ns is input for one cycle, and the low-precision clock receives it with an accuracy of 10 percent at 100MHz. For communication 0/1, it first goes Low once, and if Low is detected again, it is judged as 1; if Low is not detected, it is judged as 0.

Logical synchronization occurs at the falling edge of the first RX received data. After resynchronization, if Low is detected in the RX signal at the 3rd to 5th clock of the low-precision clock, it is judged as 1; if Low is not detected, it is judged as 0.

At this time, if the clock accuracy causes the position of 3 to shift after 5, that is, if it shifts by 2 clocks, the data cannot be correctly obtained. One cycle of data, 80ns, corresponds to 8 cycles of the low-precision clock, and a deviation of 8/6=33 percent results in false detection.

In other words, if the low-precision clock has an accuracy of 10 percent, false detection does not occur.

Referring to FIG. 5, the timing of clock switching from the active state to the standby state is explained. When the ED signal is Low, the clock is switched simultaneously with the clock change request (Standby) from the CPU. However, if the BEACON signal, which indicates the start of the transmission cycle of data received at regular intervals, conflicts with the CPU request, as shown in FIG. 5, the selector signal is set to High after the ED signal goes Low, and the clock is switched from high-precision to low-precision. After switching, the PLL is stopped, and it enters the standby state.

Referring to FIG. 6, the timing of clock switching from the standby state to the active state is explained. After receiving data and filtering valid (VALID) data, it is necessary to switch the clock to high precision at the timing of activation. In this case, after a clock change request (RUN) is received and it is confirmed that the ED signal is Low, the clock is switched. The MCU 302 performs processing. Then, after the next BEACON arrives and synchronizes with the high-precision clock, data transmission is performed. In other words, transmission is on hold until the BEACON arrives.

Thus, a semiconductor device and a method for driving a semiconductor device that reduce communication power consumption using a filter circuit to realize a partial network can be provided.

Although the invention made by the inventor has been specifically described based on the embodiment, the present invention is not limited to the embodiment already described, and it is needless to say that various modifications can be made without departing from the gist thereof. For example, while a MAC address was used when passing through the filter, it is not limited to MAC addresses, and IP (Internet Protocol) addresses, TCP (Transmission Control Protocol) port numbers, etc., may also be used.

What is claimed is:

1. A semiconductor device comprising:
a PLCA (PHY Level Collision Avoidance) circuit that receives data including the MAC (Media Access Control) address of an ECU (Electronic Control Unit) that performs processing and avoids physical collisions;
a MAC address circuit having a unique MAC address of an MCU (Micro Controller Unit) included in the ECU; and
a filter circuit that determines whether the MAC address included in the received data matches the unique MAC address of the MCU.

2. The semiconductor device according to claim 1, further comprising: a system control circuit including a high-precision clock circuit that generates a high-precision clock, a PLL (Phase Locked Loop) circuit, and a standby control circuit that transitions the high-precision clock circuit from a standby state to an active state,
wherein if the MAC address included in the received data matches the unique MAC address of the MCU, the filter circuit sends an activation signal to the standby control circuit, and the standby control circuit activates the high-precision clock circuit.

3. The semiconductor device according to claim 2, further comprising: a low-precision clock circuit that generates a low-precision clock, and a selector circuit that switches between the high-precision clock and the low-precision clock,
wherein if the MAC address included in the received data does not match the unique MAC address of the MCU, the selector circuit switches from the high-precision clock to the low-precision clock and sends the clock to the PLCA circuit.

4. The semiconductor device according to claim 3, further comprising a control circuit that controls the selector circuit so that switching from the high-precision clock to the low-precision clock does not occur during communication.

5. The semiconductor device according to claim 4,
wherein the standby control circuit, the low-precision clock circuit, the control circuit, the selector circuit, the PLCA circuit, and the filter circuit are arranged in a first area where power is always input.

6. The semiconductor device according to claim 5,
wherein the MCU includes a CPU (Central Processing Unit) and RAM (Random Access Memory), and the CPU, RAM, high-precision clock circuit, PLL circuit, and MAC address circuit are arranged in a second area where power is not always input.

7. The semiconductor device according to claim 1,
wherein the ECU includes a PMD transceiver that sends an ED signal indicating the communication status on the bus and an RX signal indicating the data to the MCU.

8. The semiconductor device according to claim 7,
wherein the ED signal is sent to the PLCA circuit and the control circuit, and the RX signal is sent to the PLCA circuit.

9. A method for driving a semiconductor device,
wherein the PLCA circuit receives data including the MAC (Media Access Control) address of an ECU (Electronic Control Unit) that performs processing and avoids physical collisions, the MAC address circuit has a unique MAC address of an MCU (Micro Controller Unit) included in the ECU, and the filter circuit determines whether the MAC address included in the received data matches the unique MAC address of the MCU.

10. The method according to claim 9, further comprising:
a system control circuit including a high-precision clock circuit that generates a high-precision clock, a PLL circuit, and a standby control circuit that transitions the high-precision clock circuit from a standby state to an active state,
wherein if the MAC address included in the received data matches the unique MAC address of the MCU, the filter circuit sends an activation signal to the standby control circuit, and the standby control circuit activates the high-precision clock circuit.

11. The method according to claim 10, further comprising:
a low-precision clock circuit that generates a low-precision clock, and a selector circuit that switches between the high-precision clock and the low-precision clock,
wherein if the MAC address included in the received data does not match the unique MAC address of the MCU, the selector circuit switches from the high-precision clock to the low-precision clock and sends the clock to the PLCA circuit.

12. The method according to claim 11, further comprising:
a control circuit that controls the selector circuit so that switching from the high-precision clock to the low-precision clock does not occur during communication.

13. The method according to claim 12,
wherein the standby control circuit, the low-precision clock circuit, the control circuit, the selector circuit, the PLCA circuit, and the filter circuit are arranged in a first region where power is constantly supplied.

14. The method according to claim 13,
wherein the MCU includes a CPU (Central Processing Unit) and RAM (Random Access Memory), and the CPU, RAM, high-precision clock circuit, PLL circuit, and MAC address circuit are arranged in a second region where power is not constantly supplied.

15. The method according to claim 9,
wherein the ECU includes a PMD transceiver that transmits an ED signal indicating the communication status on the bus and an RX signal indicating the data to the MCU.
